(19) United States
(12) Patent Application Publication
(10) Pub. No.: US 2009/0321577 A1
(43) Pub. Date: Dec. 31, 2009

(54) PROTECTIVE DEVICES FOR AIRCRAFT FUEL FILLER PORTS

(76) Inventors: Marcos Vinicius, Sao Paulo (BR); Mauro Tanaka Xavier, Sao Paulo (BR); Rodrigo Goncalves Ribeiro, San Paulo (BR)

Correspondence Address: NIXON & VANDERHYE, PC, 901 NORTH GLEBE ROAD, 11TH FLOOR, ARLINGTON, VA, 22203, US

(21) Appl. No.: 12/163,900

(22) Filed: Jun. 27, 2008

(51) Int. Cl. B64D 37/00

(52) U.S. Cl. 244/135 R

(57) ABSTRACT

Protective devices are provided subjacent to the filler port within an aircraft's wing fuel tank so as to protect the lower wing skin from being struck by a nozzle associated with refueling equipment. The protective devices for an aircraft fuel filler port may be associated with an aircraft wing tank and preferably include a generally cylindrical side wall structure and a hemispherical bottom apertured wall joined to an annular bottom edge of the side wall. The hemispherical bottom apertured wall may include a screen mesh, but apertured hemispherical cup-shaped members may also be employed and achieve equivalent benefits.

### FIELD OF THE INVENTION

The devices disclosed herein relate generally to aircraft fuel systems. In preferred forms, the disclosed devices serve to minimize (if not prevent entirely) aircraft wing skin damage that may occur during gravity refueling operations of an aircraft's on-board wing fuel tanks.

### BACKGROUND OF THE INVENTION

Aircraft carry an on-board supply of engine fuel by means of fuel tanks defined by an internal volume of the aircraft's wing structure between the wing's upper and lower structural panels (known in the art as “skins”). Sometimes the wing tanks may include a fuel bladder located within the wing structure between the upper and lower wing skins so as to contain a desired quantity of fuel. In either the wet wing tank design or a bladder wing tank design, the wing tanks may be replenished with fuel by ground based refueling equipment (e.g., fuel tanker vehicles) through capped filler ports. In gravity fill systems, these capped filler ports are located in the upper wing skin and adapted to receive a filler nozzle associated with the refueling equipment.

It can therefore be appreciated that care must be taken to prevent the filler nozzle from being inserted into the filler port to an extent that would cause contact with, and thus potential damage to, the lower wing skin. In order to minimize or prevent such damage, aircraft manufacturers have developed devices located internally within the wing tank that limit the extent to which a filler nozzle may be inserted therein. These conventional devices tend however to be structurally complex (and hence expensive) since they typically include a cylindrical basket-type screen structure subjacent to the filler port designed to permit fuel to flow therethrough but to provide a structural barrier limiting the extent to which the fuel filler nozzle may be inserted into the wing tank. These conventional cylindrical basket-type structures however have a planar bottom end wall against which the fuel refilling nozzle can rest. The weight of the nozzle against the bottom wall in addition to the weight of the fuel exiting the nozzle during a refilling operation create stresses on the annular junction between the bottom wall and the cylindrical side wall that can possibly damage the screen to an extent it no longer serves a protective function.

According to copending and commonly owned U.S. patent application Ser. No. 11/953,836 filed on Dec. 10, 2007 (the entire content of which is expressly incorporated hereinto by reference, protective devices for an aircraft fuel filler port associated with an aircraft wing tank that include a wall structure defining a dependent surface which slopes downwardly and laterally relative to the aircraft's longitudinal centerline. As such, a fuel filler nozzle when inserted into the fuel filler port will be angularly oriented laterally (preferably in an aircraft inboard direction).

### SUMMARY OF THE INVENTION

Broadly, the subject matter disclosed herein provides for protective devices for an aircraft fuel filler port associated with an aircraft wing tank that include a generally cylindrical side wall structure and a hemispherical bottom apertured wall joined to an annular bottom edge of the side wall. In some preferred embodiments, the hemispherical bottom apertured wall includes a screen mesh, but apertured hemispherical cup-shaped members may also be employed and achieve equivalent benefits.

Certain embodiments will comprise an upper annular cap ring for attachment to an upper wing skin of the aircraft wing so that the device is dependently fixed in coaxial alignment with the fuel filler port. The side wall structure includes apertures. An annular strap may be provided in some embodiments so as to join the apertured bottom wall to the annular lower edge region of the side wall.

These and other aspects and advantages will become more apparent after careful consideration is given to the following detailed description of the preferred exemplary embodiments thereof.

### BRIEF DESCRIPTION OF THE ACCOMPANYING DRAWINGS

Reference will hereinafter be made to the accompanying drawings, wherein like reference numerals throughout the various FIGURES denote like structural elements, and wherein;

FIG. 1 is a perspective view of an aircraft during a gravity refueling operation;

FIG. 2 is an enlarged perspective view of the aircraft's wing fuel filler port during a refueling operation as taken along line 2-2 in FIG. 1;

FIG. 3 is exploded perspective view of the filler port mounted within a fuel tank associated with the aircraft's port wing which includes a protective device as depicted in FIG. 2;

FIG. 4 is an exploded view of the protective device shown in FIG. 3;

FIG. 5 is front perspective view of the protective device depicted in FIG. 3;

FIGS. 6 is a front elevational view of the device depicted in FIG. 5; and

FIGS. 7 and 8 are top and bottom plan views, respectively, of the device depicted in FIG. 5.

### DETAILED DESCRIPTION OF THE INVENTION

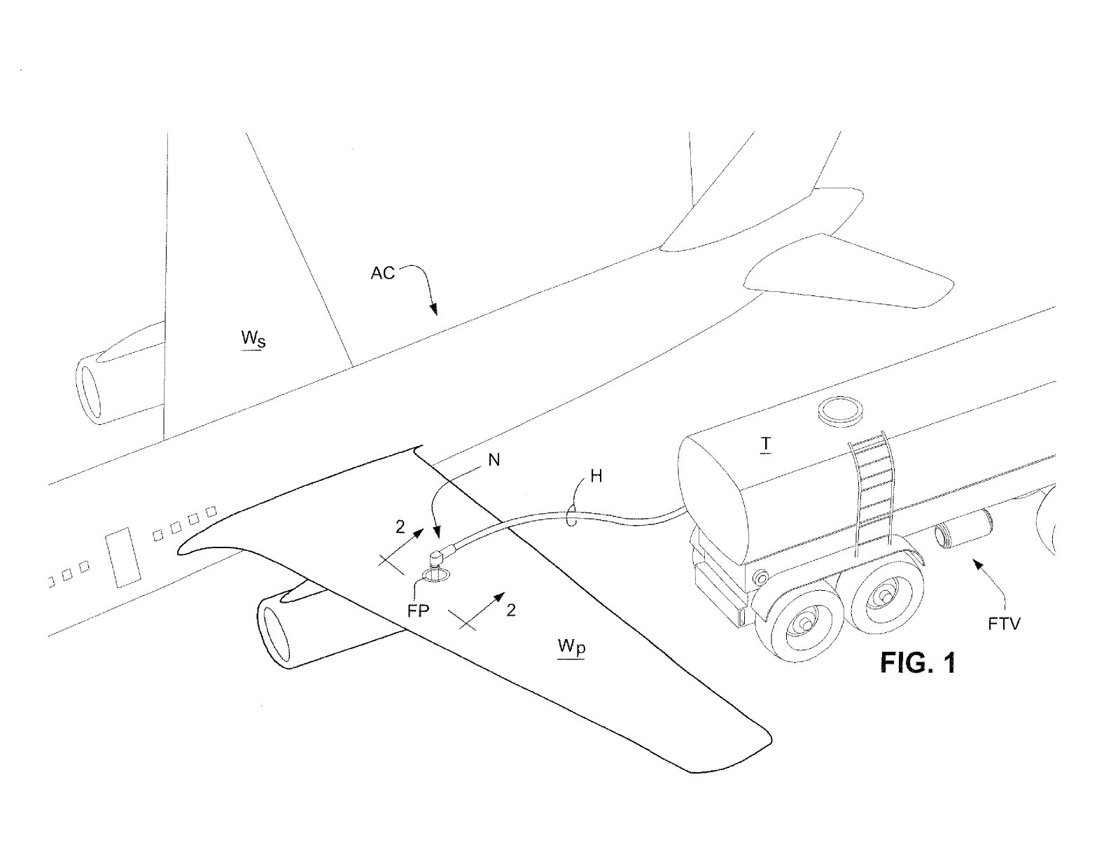

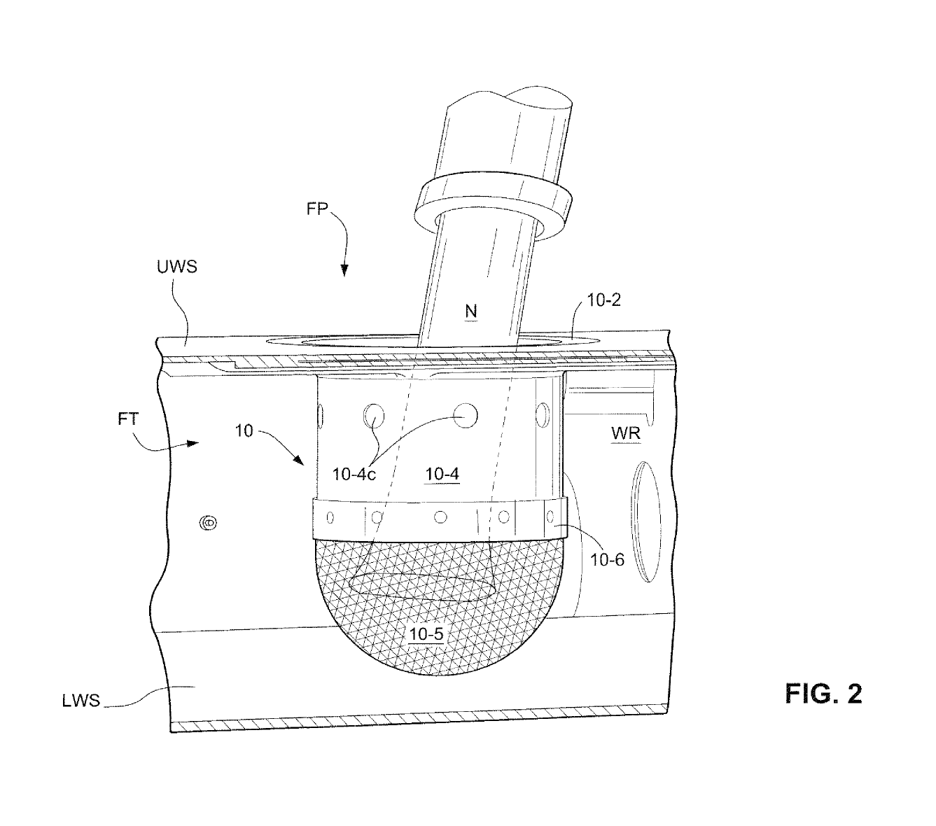

As described briefly above, aircraft are serviced during a refueling operation so as to replenish the fuel quantity within the aircraft's wing fuel tanks. A typical refueling operation for an aircraft AC having gravity filled wing fuel tanks is depicted in accompanying FIG. 1. As shown, the aircraft AC may be refueled by suitable refueling equipment which in the scene depicted in FIG. 1 is a fuel tanker vehicle FTV. The aircraft AC is provided with internal wing fuel tanks FT (see FIG. 2) within each of its port and starboard wings Wp and Ws which are accessed by a filler port FP. In this regard, only the filler port FP associated with the aircraft's port wing Wp is depicted in FIG. 1 for ease of discussion. However, it will be appreciated that a similar filler port is provided at a mirror image location on the starboard wing Ws. Also, depending on the aircraft's fuel system, a plurality of wing fuel tanks, and hence filler ports, may be provided. The devices discussed herein are applicable to all such gravity-filled fuel tank systems.

The fuel tanker vehicle FTV includes a fuel hose FH which fluid-connects the tank T with an operator-actuated nozzle N. The fuel tanker vehicle FTV will also typically contain a pump (not shown) so as to provide pressurized flow assist to the fuel contained within the tank. The fuel within the tank T will thus flow through the fuel hose FH and be discharged from the nozzle N into the fuel filler port FP of the aircraft's wing tank.

Accompanying FIG. 2 depicts in greater detail the nozzle N inserted into the fuel filler port FP during a refueling operation. In the scene depicted in FIG. 2, the aircraft's fuel tank FT is defined between upper and lower wing skins UWS and LWS, respectively. Structural integrity of the wing is provided by wing ribs WR which maintain the separation of the wing skins UWS and LWS. Thus, the fuel filler port FP provides access to the fuel tank FT through the upper wing skin UWS as discussed briefly above. In this regard, it will be appreciated that, if left unprotected, careless insertion of the nozzle into the fuel tank FT through the filler port FP could cause the end of the nozzle to strike and potentially damage the lower wing skin LWS.

According to the present invention, a protective device 10 is provided subjacent to the filler port FP within the fuel tank FT so as to protect the lower wing skin LWS from such potential damage. In this regard, as shown in FIG. 2, when inserted into the filler port FP, the nozzle N is surrounded by the protective device 10 thereby preventing the nozzle from striking the lower wind skin LWS if inserted into the filler port FP to its full length.

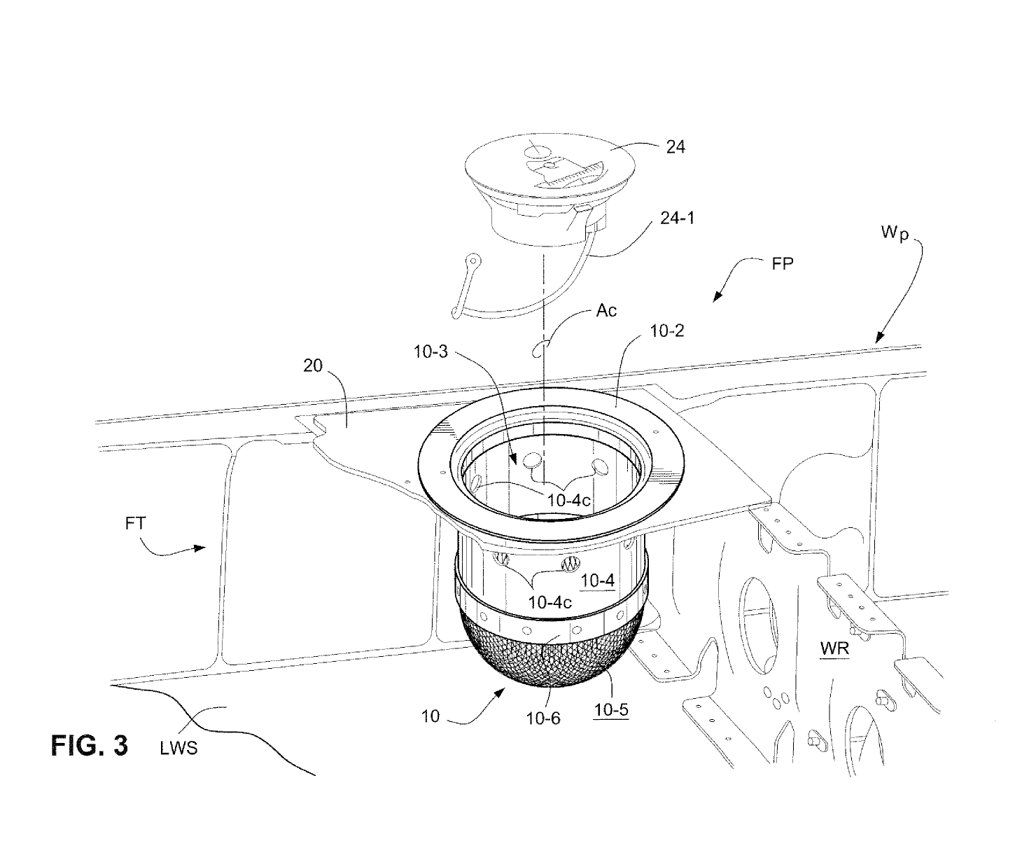

Accompanying FIG. 3 shows and exploded perspective view of the filler port FP mounted within a fuel tank FT associated with the aircraft's port wing Wp. In this regard, the device 10 includes an annular collar 10-2 at its upper end which defines a circular opening 10-3 aligned coaxially with the filler port's central axis Ac. The upper wing skin UWS includes a mounting structure 20 to provide structural support to the collar 10-2 associated with the cap member 24.

The cap member serves to close the filler port FP when refueling is complete. Preferably, the cap member 24 includes a tether 24-1 which is attached to the collar 10-2 so as to maintain the cap 24 in the vicinity of the filler port FP when uncapped therefrom.

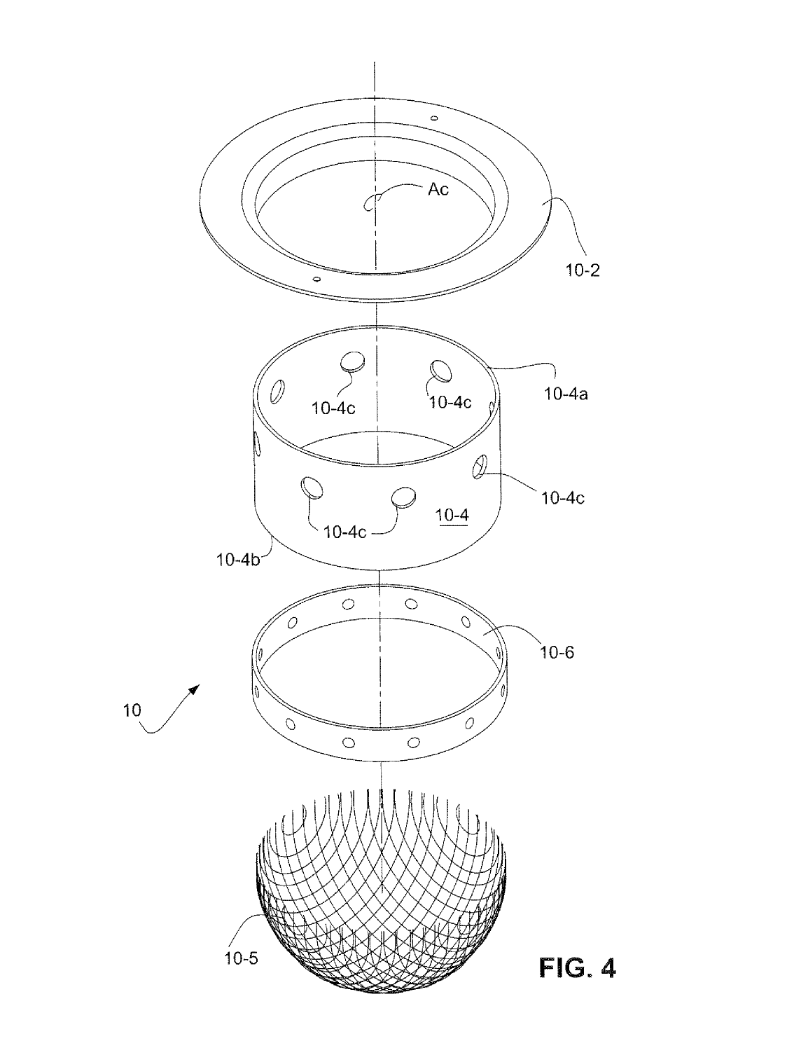

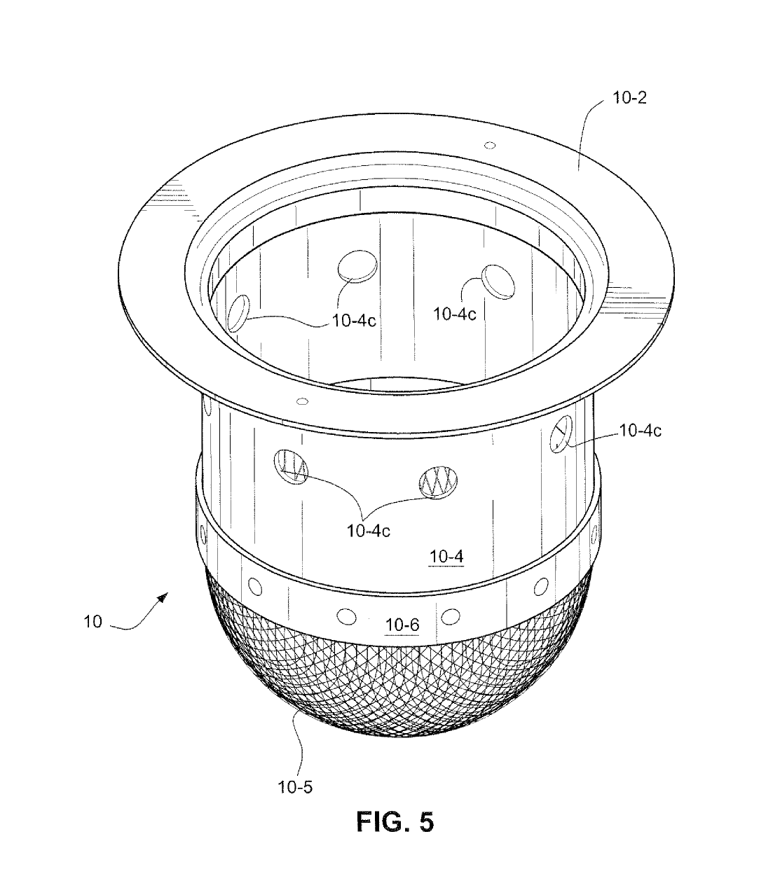

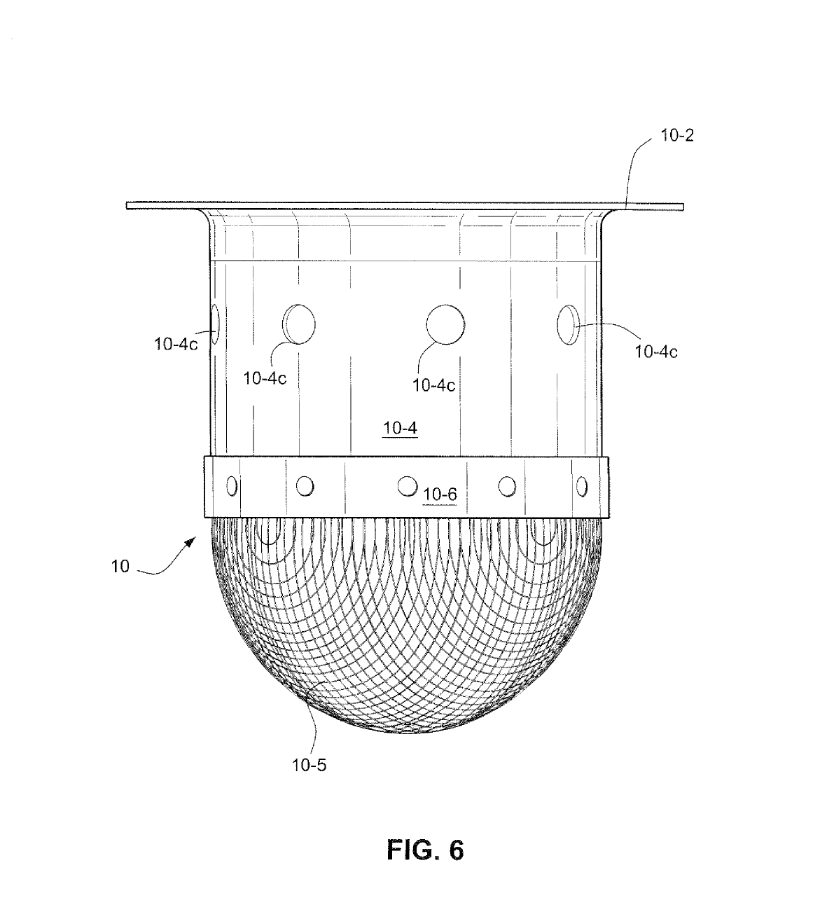

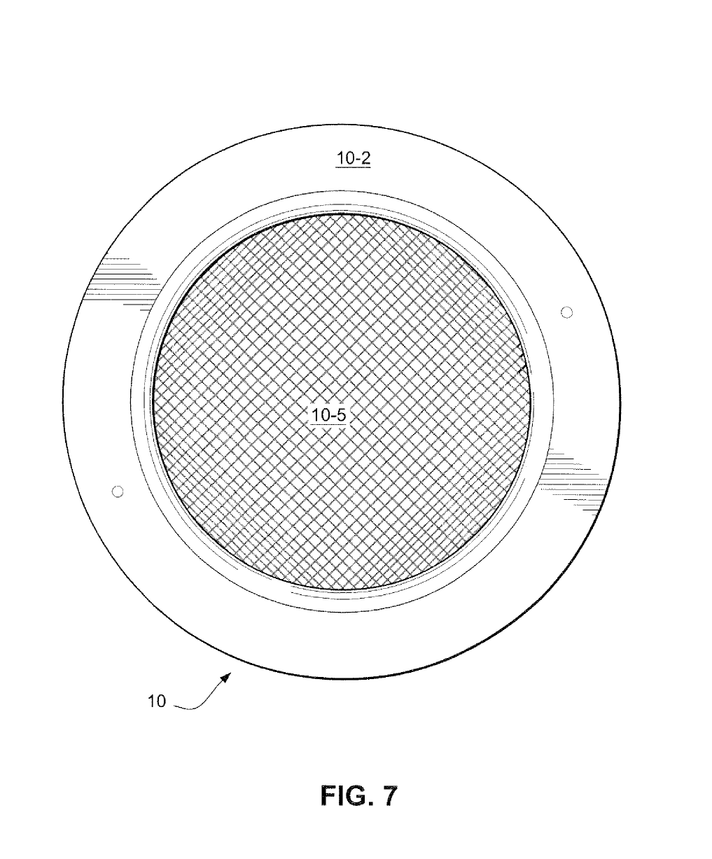

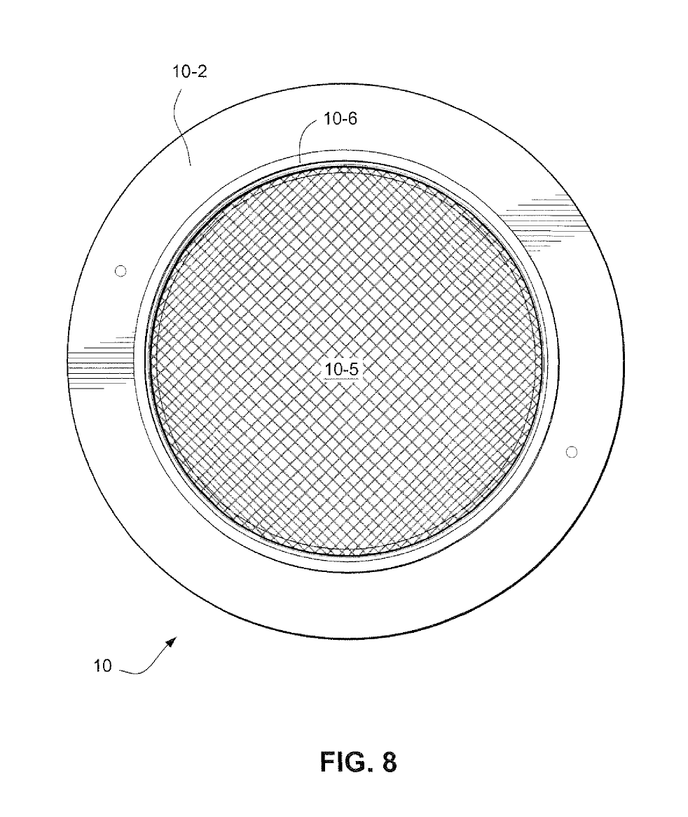

As is perhaps best shown in FIGS. 4-98, the protective device 10 includes a cylindrical body structure 10-4 that is attached at its upper annular edge region 10-4a to the collar 10-2. The open lower end of the cylindrical body structure 10-4 defined by a lower annular edge region 10-4b is covered by a hemispherical apertured bottom wall 10-5. Preferably, the apertured bottom wall 10-5 is joined to the lower annular edge region 10-4b of the cylindrical body structure 10-4 by means of an annular strap 10-6. The strap 10-6 and hence the bottom wall 10-5 may thus be immovably fixed to the lower edge region 10-4b of the cylindrical body structure 10-4 by means of riveting, bolting, welding, soldering or like techniques. The body structure 10-4 may be formed of a solid sheet of material (e.g., aluminum) and provided with openings 10-4c for purpose of weight reduction.

Although the bottom wall 10-5 is depicted in the accompanying drawing FIGURES as being a screen mesh, it will be understood that this represents a particularly preferred embodiment of the invention. Thus the bottom wall 10-5 may be in the form of a cup-shaped structure having a dense plurality of apertures therein. Suffice it to say, that however embodied, the hemispherical geometry of the apertured bottom wall 10-5 allows the fuel to be discharged therefrom substantially radially outwardly thereby minimizing (if not eliminating entirely) stress accumulation at the annular region where the bottom wall 10-5 is joined to the lower edge region 10-4b of the cylindrical body member 10-4.

In addition, the nozzle N will be prevented from striking the lower wing skin LWS when inserted through the opening 10-3 since the depth of its insertion is limited by means of the bottom wall 10-5.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A protective device for an aircraft fuel filler port associated with an aircraft wing fuel tank comprising a generally cylindrical side wall structure, and a hemispherical apertured bottom wall attached to an annular lower edge region of the side wall.

2. The protective device as in claim 1, wherein the hemispherical apertured bottom wall includes a screen mesh.

3. The protective device as in claim 1, further comprising an upper annular collar for attachment to an upper wing skin of the aircraft wing so that the device is dependently fixed in coaxial alignment with the fuel filler port.

4. The protective device as in claim 1, wherein the side wall structure includes apertures.

5. The protective device as in claim 1, further comprising an annular strap which joins the apertured bottom wall to the annular lower edge region of the side wall.

6. An aircraft fuel filler port comprising:
a cap ring defining a fuel filler port opening;
a cap for closing the fuel filler port opening; and
a protective device for dependent attachment to the cap ring, the protective device having a generally cylindrical side wall structure, and a hemispherical apertured bottom wall attached to an annular lower edge region of the side wall.

7. The protective device as in claim 6, wherein the hemispherical apertured bottom wall includes a screen mesh.

8. The protective device as in claim 6, further comprising an upper annular collar for attachment to an upper wing skin of the aircraft wing so that the device is dependently fixed in coaxial alignment with the fuel filler port.

9. The protective device as in claim 6, wherein the side wall structure includes apertures.

10. The protective device as in claim 6, further comprising an annular strap which joins the apertured bottom wall to the annular lower edge region of the side wall.

11. An aircraft having a wing fuel tank which comprises a fuel filler port as in any one of claims 6-10.
